(19) United States
(12) Patent Application Publication
(10) Pub. No.: US 2004/0155749 A1
(43) Pub. Date: Aug. 12, 2004

(54) Fuse connector

(75) Inventor: Masayasu Fujii, Yokkaichi-City (JP)

Correspondence Address: CASELLA & HESPOS, 274 MADISON AVENUE, NEW YORK, NY, 10016

(73) Assignee: Sumitomo Wiring Systems, Ltd., Yokkaichi-City (JP)

(21) Appl. No.: 10/744,337

(22) Filed: Dec. 23, 2003

(30) Foreign Application Priority Data
Dec. 24, 2002 (JP) 2002-371706

(51) Int. Cl. H01H 85/02

(52) U.S. Cl. 337/187

(57) ABSTRACT

A fuse connector has a housing (10) with a plurality of front-stops (18A, 18B) for enabling a plurality of kinds of fuses (30A, 30B) to be locked even though casings (31A, 31B) and tab terminals (32A, 32B) of the fuses (30A, 30B) have different positional relationships along a mounting direction of the fuses (30A, 30B) into the housing (10). Thus, regardless of which of the two kinds of fuses (30A, 30B) is mounted, the fuse (30A, 30B) is located at a specified front-limit position, and the tab terminals (32A, 32B) can be connected with terminal fittings (20) at proper positions. Therefore, it is sufficient to prepare only one housing (10) for two kinds of fuses (30A, 30B).

### BACKGROUND OF THE INVENTION

1. Field of the Invention

The present invention relates to a fuse connector.

2. Description of the Related Art

Japanese Unexamined Patent Publication No. H09-63457 discloses a fuse connector with two terminal fittings that form part of a series circuit. The two terminal fittings are accommodated in a housing that is configured for detachably receiving a fuse. The fuse has two tab terminals that can be connected with the terminal fittings to establish an electrical connection between the terminal fittings for closing the series circuit. The series circuit is opened if a fusible portion of the fuse is burned out or if the fuse is detached from the housing.

The fusible portion of the fuse is accommodated in a casing and the tab terminals are exposed outside the casing. A fuse of the type is used widely and is shown in FIGS. 5 and 6. The fuse has two tab terminals that project forward (right in FIGS. 5 and 6) from the front surface of a substantially rectangular casing. Thus, a dimension of this fuse along forward and backward directions is large. In view of this problem, the fuse of FIGS. 9 and 10 has been constructed so that tab terminals project along the opposite lateral edges of a casing as shown in FIGS. 9 and 10. The tab terminals do not project large distances forward from the casing in the fuse of this type. Thus, the entire fuse is shorter, and the fuse is suited well for miniaturization.

The casing of the fuse is locked in the housing by a receiving portion of the housing that stops the fuse at a front-limit position. The tab terminals should contact the terminal fittings at proper positions when the fuse is at the front limit position. However, the two kinds of fuses described above have casings and tab terminals at different positions. Thus, the casings of the respective fuses are mounted at different positions in the housings, and special housings corresponding to the respective fuses have been necessary.

The present invention was developed in view of the above problems and an object thereof is to provide a fuse connector commonly usable for a plurality of kinds of fuses.

### SUMMARY OF THE INVENTION

The invention relates to a fuse connector into which at least one fuse is to be mounted. The fuse connector has two terminal fittings and a housing for accommodating the terminal fittings. The housing has a plurality of front-stops for enabling a plurality of kinds of fuses to be locked, even though the casings and/or the tab terminals of the fuses have different positional relationships along a mounting direction of the fuses into the housing. Thus, any of the fuses is located at a specified front-limit position, and the tab terminals are connected with the terminal fittings at proper positions. Therefore, it is sufficient to prepare only one housing for the plurality of kinds of fuses.

A casing of the fuse preferably is locked into the housing to hold the fuse at a front-limit position and the two tab terminals of the fuse are connected with the terminal fittings.

The front-stops may have two slanted surfaces whose spacing narrows along the mounting direction of the fuse. The fuse is guided to the widthwise center by the slanted surfaces in the process of mounting the fuse.

The fuse preferably has at least one lock that contacts the front-stops so that the fuse is held in the housing and cannot move any farther forward.

The housing preferably has at least one guide for guiding the fuse into the housing. The at least one guide preferably comprises two opposed guides with recessed surfaces. The casing of the fuse preferably is fit into the recesses so that loose vertical and/or transverse movements are restricted.

The housing preferably comprises at least one front wall configured to stop the terminal fitting at its front-limit position in the housing.

The terminal fittings each preferably have two resilient contact pieces, and the tabs of the fuse are thrust between the resilient contact pieces.

The housing preferably has first front-stops for a first type of fuses and second front-stops for a second type of fuses. The first front-stops preferably are located slightly before the second front-stops.

A distance between the corresponding first front-stops preferably exceeds a shortest spacing between the corresponding second front-stops.

Slanted surfaces of the second front-stops preferably are more inward along widthwise direction than the first front-stops.

These and other objects, features and advantages of the invention will become more apparent upon reading the following detailed description and accompanying drawings. It should be understood that even though embodiments are separately described, single features thereof may be combined to additional embodiments.

### BRIEF DESCRIPTION OF THE DRAWINGS

FIG. 1 is a vertical section showing a state where terminal fittings are accommodated in a housing according to one embodiment of the invention.

FIG. 2 is a front view showing the state where the terminal fittings are accommodated in the housing.

FIG. 3 is a vertical section showing a state where a first fuse is mounted in the housing.

FIG. 4 is a horizontal section showing a locked state of the first fuse by first front-stop portions.

FIG. 5 is a side view of the first fuse.

FIG. 6 is a plan view of the first fuse.

FIG. 7 is a vertical section showing a state where a second fuse is mounted in the housing.

FIG. 8 is a horizontal section showing a locked state of the second fuse by second front-stop portions.

FIG. 9 is a side view of the second fuse.

FIG. 10 is a plan view of the second fuse.

### DETAILED DESCRIPTION OF THE PREFERRED EMBODIMENTS

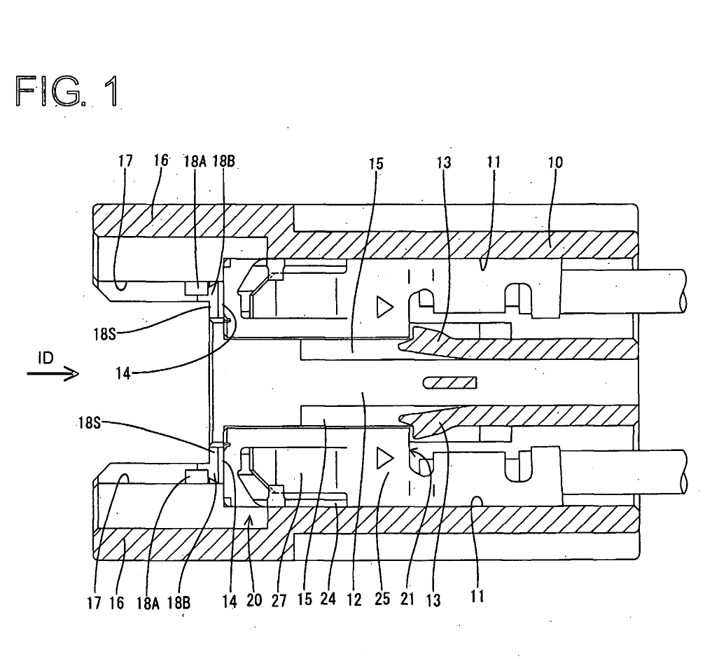

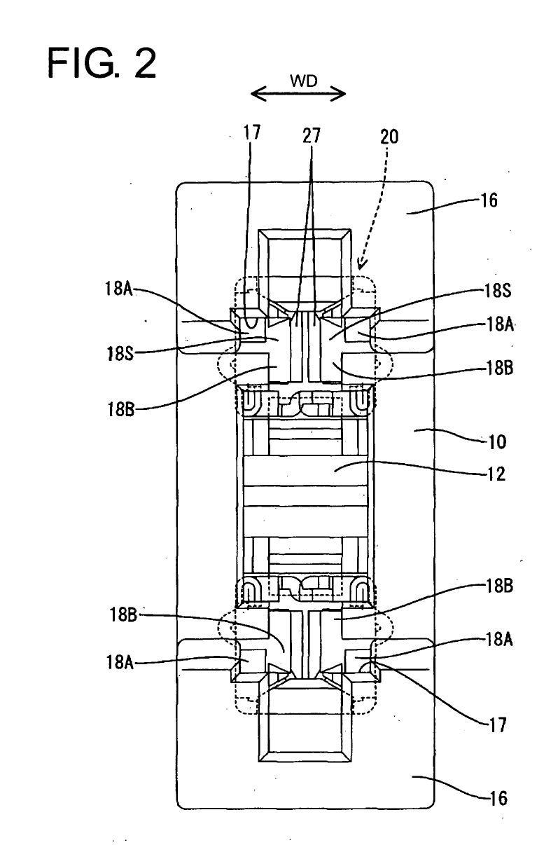

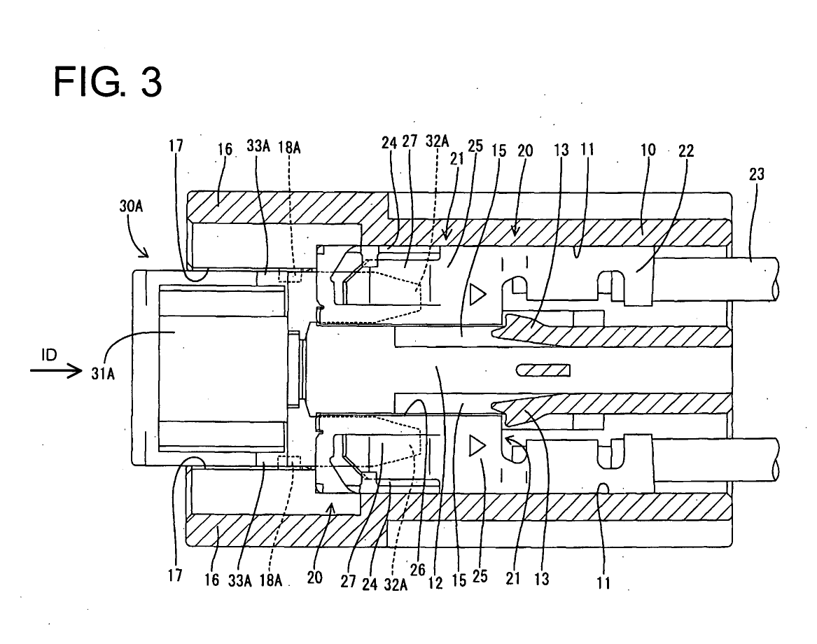

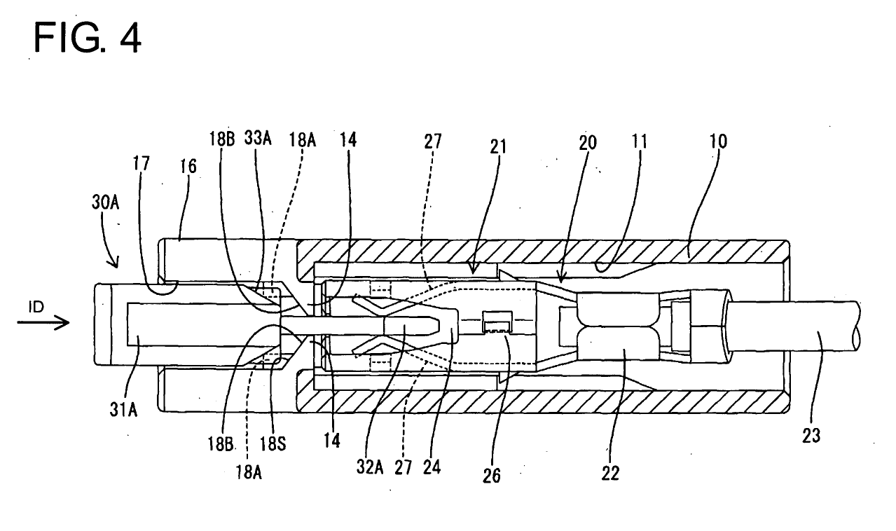

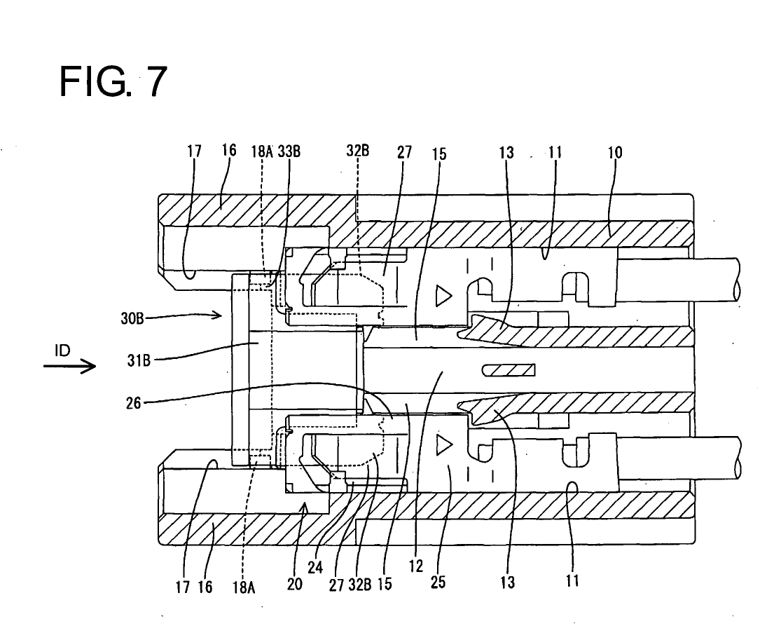

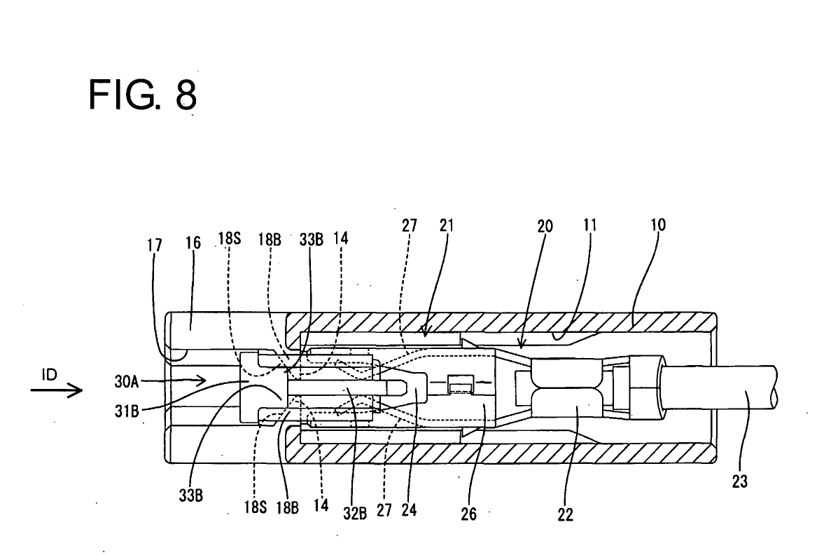

A fuse connector according to the invention includes a housing 10 and two terminal fittings 20 accommodated in the housing 10, as shown in FIGS. 1 to 10. Two kinds of fuses 30A, 30B are mountable into the housing 10.

The housing 10 has a substantially box shape, and two symmetrically arranged cavities 11 are formed in the housing 10 so that an inter-terminal space 12 is defined between the cavities 11. The cavities 11 and the inter-terminal space 12 are open in both front and rear ends of the housing 10. Locks 13 are cantilevered forwardly (leftward in FIG. 1) in each cavity 11 from the partition walls that partition the cavities 11 and the inter-terminal space 12. The locks 13 are at a substantially longitudinal middle in each cavity. The partition walls are cut at substantially widthwise middle portions before the locks 13 so that the upper cavity 11, the inter-terminal space 12 and the lower cavity 11 communicate with each other.

Front walls 14 project in from the opposite left and right walls at the front end of each cavity 11. A clearance between the two front walls 14 communicates with the cavity 11 and the inter-terminal space 12 and a tab terminal 32A, 32B of a fuse 30A, 30B is insertable in an inserting direction ID into the clearance between the front walls 14. The front walls 14 are designed to stop the terminal fitting 20 inserted into the cavity 11 at its front-limit position. Each cavity 11 also has two supports 15 that project from the opposite left and right walls. The supports 15 are at substantially the same height as the partition walls and are elongated in forward and backward directions. The terminal fitting 20 inserted into the cavity 11 is prevented from loosely moving into the inter-terminal space 12 by the supports 15.

The housing 10 also has upper and lower guides 16 that project forward from the front-end surface of the housing 10. The guides 16 guide the fuse 30A, 30B along the inserting direction and into the housing 10. Each guide 16 has a recess 17 in the surface that faces the opposite guide 16. The recesses 17 are open in the front-end surfaces of the guides 16. A distance between the recesses 17 is slightly larger than the widths of the casings 31A, 31B of the fuses 30A, 30B, and a forming area of the recesses 17 along the widthwise direction WD corresponds to an opening area of the inter-terminal space 12 in the front end surface of the housing 10.

The left and right front walls 14 are at the back end of each of the upper and lower recesses 17 and slanted surfaces 18S are defined on the front surfaces of the front walls 14, which is the back end surface of the recess 17. The distance between the slanted surfaces 18S is narrowed toward the back. The front walls 14, including the left and right slanted surfaces 18S, form left and right second front-stops 18B for stopping the second fuse 30B at its front-limit position.

Small rectangular left and right first front-stops 18A project from the facing surfaces of the upper and lower recesses 17 at locations near the second front-stops 18B and at the back end of each of the upper and lower recesses 17. The first front-stops 18A stop the first fuse 30A at its front-limit position. The first front-stops 18A are slightly before the slanted surfaces 18S of the second front-stops 18B, as seen in the inserting direction ID. Further, a distance between the corresponding left and right first front-stops 18A exceeds the shortest spacing between the corresponding left and right second front-stops 18B. Parts of the slanted surfaces 18S are more inward along widthwise direction WD than the first front-stops 18A when viewed from the front.

Each terminal fitting 20 is formed by stamping, cutting, embossing and/or bending a metallic plate and is narrow and long along forward and backward directions. A connecting portion 21 is formed at the front of the terminal fitting 20 and is configured for connection with the tab terminal 32A, 32B of the fuse 30A, 30B. A wire-crimping portion 22 is formed at the rear of each terminal fitting 20 and is configured to be crimped, bent or folded into connection with a wire 23. The connecting portion 21 is a substantially rectangular tube with a bottom plate 24, left and right plates 25 and a ceiling plate 26. Left and right resilient contact pieces 27 are accommodated in the connecting portion 21. The ceiling plate 26 has an escaping portion 28 that is cut to extend back from the front end, and the resilient contact pieces 27 are exposed up through the escaping portion 28.

The terminal fitting 20 is inserted into the lower cavity 11 from behind, with the ceiling plate 26 faced up, and the terminal fitting 20 of the same shape is inserted into the other upper cavity 21 in an inverted posture with the ceiling plate 26 faced down. In an inserted state, the front end of the connecting portion 21 contacts the front walls 14 to prevent further forward movement of the terminal fitting 20. Additionally, the lock 13 engages the rear edge of the connecting portion 21 to prevent rearward movement of the terminal fitting 20. Further, the resilient contact pieces 27 face substantially forward via the clearance between the front walls 14 and face the inter-terminal space 12 through the escaping portion 28 to enable connection with the fuse 30A, 30B.

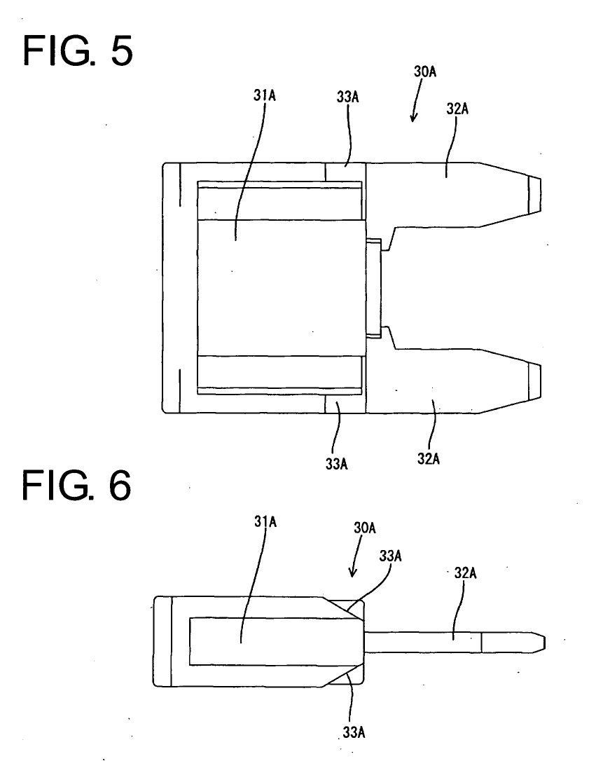

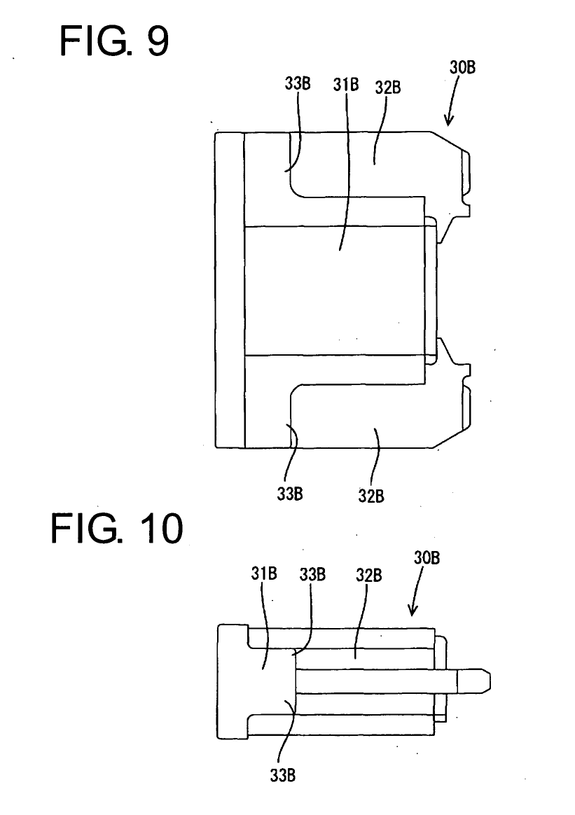

The first fuse 30A or the second fuse 30B are mountable into the housing 10. The first fuse 30A has a casing 31A that accommodates a fusible portion (not shown) and tab terminals 32A that project back from the casing 31A, as shown in FIGS. 5 and 6. The second fuse 30B has a casing 31B that accommodates a fusible portion (not shown) tab terminals 32B that project out from the casing 31B, as shown in FIGS. 9 and 10. The fuses 30A, 30B are to be mounted into the housing 10 from the front and along the inserting direction ID. Thus, the fuses 30A, 30B are positioned by the engagement of the casings 31A, 31B with the housing 10 and will not move any further forward.

The casing 31A of the first fuse 30A has a substantially rectangular shape when viewed sideways and the tab terminals 32A project from the rear end surface of the casing 31A. The casing 31B of the second fuse 30B has a substantially T-shape turned by 90° when viewed sideways, and the tab terminals 32B are fit into cut-aways that extend along the upper and lower edges of the casing 31B. The casing 31B and the tab terminals 32B together take a substantially rectangular shape when viewed sideways. Specifically, the tab terminals 32A of the first fuse 30A are displaced along the forward and backward directions from the casing 31B, whereas the casing 31B and the tab terminals 32B of the second fuse 30B are at substantially the same positions with respect to forward and backward directions. Thus, the positional relationships of the casings 31A, 31B and the tab terminals 32A, 32B with respect to forward and backward directions are offset in the fuses 30A, 30B.

The fuses 30A, 30B are positioned by bringing the casings 31A, 31B substantially into engagement with the front-stops 18A, 18B of the housing 10. First locks 33A are formed at each of the upper and lower ends of the casing 31A of the first fuse 31A and are comprised of substantially transversely symmetrical slanted surfaces. The slanted surfaces of the first locks 33A at each of the left and right ends are oblique and narrow a spacing therebetween along the mounting direction ID of the fuse 30A into the housing 10.

On the other hand, left and right second locks 33B of the second fuse 30B are formed at the front end of each of the upper and lower ends of a projection that is narrower than the casing 31B of the second fuse 30B. The second locks 33B are defined by right angle corners where the rear end surface of the projection and the opposite left and right side surfaces thereof meet.

The first fuse 30A can be inserted into the housing 10 along the inserting direction ID and to a proper mount position. Thus, the left and right first locks 33A contact the first front-stops 18A from behind. As a result, the first fuse 30A cannot move any further forward in the housing 10. In the mounted state, the casing 31A is accommodated in the space between the two guides 16. Additionally, the tab terminals 32A enter the upper and lower cavities 11 and enter the connecting portions 21 of the upper and lower terminal fittings 20. Accordingly, the tab terminals 32A thrust themselves between the resilient contact pieces 27. Thus, the terminal fittings 20 and the tabs terminals 32A are connected at a specified contact pressure created by the resilient restoring forces of the resilient contact pieces 27, and the two terminal fittings 20 are connected electrically via the first fuse 30A. The first fuse 30A is guided and mounted into the housing 10 by fitting the upper and lower ends of the casing 31A into the recesses 17 to have loose vertical and/or transverse movements restricted.

The second fuse 30B also can be inserted into the housing 10 along the inserting direction ID and to a proper mount position. Thus, the left and right second locks 33B are inserted between the first front-stops 18A and contact the slanted surfaces 18S of the second front-stops 18B from behind. As a result, the second fuse 30B is held in the housing 10 so as not to move any further forward. In the mounted state, the casing 31B is accommodated in a space extending from the back end of the space between the two guides 16 to the front end of the inter-terminal space 12. Additionally, the tab terminals 32B enter the upper and lower cavities 11 and the connecting portions 21 of the upper and lower terminal fittings 20. Accordingly, the tab terminals 32B thrust themselves between the resilient contact pieces 27. Thus, the terminal fittings 20 and the tabs terminals 32B are connected at a specified contact pressure created by the resilient restoring forces of the resilient contact pieces 27, and the two terminal fittings 20 are connected electrically by the second fuse 30B. The second fuse 30B is guided and mounted into the housing 10 by fitting the upper and lower ends of the casing 31B into the recesses 17 to have loose vertical and/or transverse movements restricted.

The positions of the tab terminals 32A, 32B connected with the terminal fittings 20 are substantially the same in the mounted state of these two kinds of fuses 30A, 30B in the housing 10. Contrary to this, the positions of the casings 31A, 31B differ. More particularly, the casing 31A of the first fuse 30A is located before the casing 31B of the second fuse 30B.

As described above, the housing 10 is provided with two kinds of front-stops 18A, 18B for enabling the two kinds of fuses 30A, 30B having different positional relationships of the casings 31A, 31B and/or the tab terminals 32A, 32B along forward and backward direction to be locked individually. Thus, either kind of fuse 30A, 30B can be located at the specified front-limit position and the tab terminals 32A, 32B can be connected with the terminal fittings 20 at substantially proper positions. Therefore, it is sufficient to prepare only one housing 10 for two kinds of fuses 30A, 30B, and two kinds of fuses 30A, 30B can be used commonly in the fuse connector.

The second front-stops 18B are formed with the slanted surfaces 18S whose spacing is narrowed along the mounting direction ID of the second fuse 30B into the housing 10. Thus, the fuse 30B can be guided substantially to the widthwise center by the slanted surfaces 18S in the process of being mounted into the housing 10. Thus, the left and right resilient contact pieces 27 can be deformed to a substantially uniform degree and can secure a proper contact pressure.

The invention is not limited to the above described and illustrated embodiment. For example, the following embodiments are also embraced by the technical scope of the present invention as defined by the claims. Beside the following embodiments, various changes can be made without departing from the scope and spirit of the present invention as defined by the claims.

One housing corresponds to the two kinds of fuses in the foregoing embodiment. However, one housing may correspond to three or more kinds of fuses according to the present invention.

The second front-stops for locking the second fuse are formed with the slanted surfaces in the foregoing embodiment. However, the first front-stops may be formed with slanted surfaces according to the present invention.

The second fuse is locked by first and second front-stops in the foregoing embodiment. However, the second fuse may be locked only by the second front-stops according to the present invention.

The first front-stops and the second front-stops are both substantially transversely symmetrical in the foregoing embodiment. However, these front-stops may be transversely asymmetrical or the front-stop portions may be provided only at the left or right side according to the present invention.

What is claimed is:

1. A fuse connector into which at least one fuse (30A; 30B) is to be mounted, comprising:
at least two terminal fittings (20); and
a housing (10) for accommodating the terminal fittings (20;
wherein the housing (10) comprises a plurality of front-stops (18A; 18B) for enabling a plurality of kinds of fuses (30A, 30B) to be locked individually, the respective kinds of fuses (30A, 30B) having different positional relationships of their casings (31A, 31B) and their tab terminals (32A; 32B) along a mounting direction (ID) of the fuses (30A, 30B) into the housing (10).

2. The fuse connector of claim 1, wherein with the fuse (30A; 30B) mounted in the housing (10), a casing (31A; 31B) of the fuse (30A; 30B) being locked into the housing (10) to hold the fuse (30A; 30B) at a front-limit position and two tab terminals (32A; 32B) of the fuse (30A; 30B) being connected respectively with the terminal fittings (20).

3. The fuse connector of claim 1, wherein the front-stops (18A, 18B) are formed with two opposed slanted surfaces (18S) whose spacing is narrowed along the mounting direction (ID) of the fuse (30A; 30B) into the housing (10).

4. The fuse connector of claim 1, wherein when the fuse (30A; 30B) is inserted in the inserting direction (ID) to a substantially proper mount position in the housing (10), locks (33A; 33B) of the fuse (30A; 30B) contact the front-stops (18A; 18B) for preventing the fuse (30A; 30B) from moving farther forward in the housing (10).

5. The fuse connector of claim 1, wherein the housing (10) comprises opposed guides (16) for guiding the fuse (30A; 30B) into the housing (10) in the inserting direction (ID).

6. The fuse connector of claim 5, wherein the guides (16) have opposed substantially facing surfaces configured to form a recess (17), wherein the casing (31A; 31B) of the fuse (30A; 30B) being fit into the recess (17) for restricting loose transverse movements.

7. The fuse connector of claim 1, wherein the housing (10) comprises front walls (14) configured to stop the terminal fitting (20) at a front limit position in the housing (10).

8. The fuse connector of claim 1, wherein the terminal fittings (20) each comprise two resilient contact pieces (27) so that tab terminals (32A; 32B) of the fuse (30A; 30B) entering the housing (10) are thrust between the resilient contact pieces (27).

9. The fuse connector of claim 1, wherein the front stops (18A, 18B) include first front-stops (18A) for a first type (30A) of fuse (30A; 30B) and second front-stops (18B) for a second type (30B) of fuse (30A; 30B), the first front-stops (18A) being located slightly before slanted surfaces (18S) of the second front-stops (18B) as seen in the mounting direction (ID).

10. The fuse connector of claim 9, wherein a spacing between the corresponding first front-stops (18A) is larger than a shortest spacing between the corresponding second front-stops (18B).

11. The fuse connector of claim 10, wherein parts of the slanted surfaces (18S) are more inward along widthwise direction (WD) than the first front-stops (18A).

12. A fuse connector for mounting first and second different types of fuses (30A; 30B), the fuse connector comprising: a housing (10) having opposite front and rear ends, first and second cavities (11) extending into the rear end, first and second terminal fittings (20) mounted respectively in the cavities (11), a recess (17) extending into the front end and communicating with the cavities (11), first front-stops (18A) formed in the recess (17) for defining a first front limit position for the first type of fuse (30A) and second front stops (18B) formed in the recess (17) for defining a second front limit position for the second type of fuse (30B), the first and second front stops (18A, 18B) having different respective configurations and being at different respective positions in the recess (17).

13. The fuse connector of claim 12, wherein the second front-stops (18B) are formed with two opposed slanted surfaces (18S) whose spacing is narrowed along a mounting direction (ID) of the fuse (30A; 30B) into the housing (10).

14. The fuse connector of claim 12, wherein a spacing between the corresponding first front-stops (18A) is larger than a shortest spacing between the corresponding second front-stops (18B).

15. The fuse connector of claim 14, wherein parts of the slanted surfaces (18S) are more inward along widthwise direction (WD) than the first front-stops (18A).
